(19) United States
(12) Patent Application Publication
(10) Pub. No.: US 2002/0158235 A1
(43) Pub. Date: Oct. 31, 2002

(54) Negative actinic ray-sensitive paste and pattern-forming method by use of the same

(76) Inventors: Daisuke Kojima, Kanagawa-ken (JP); Genji Imai, Kanagawa-ken (JP)

Correspondence Address: Fisher Christen & Sabol, Suite 1401, 1725 K Street, N.W., Washington, DC, 20006, US

(21) Appl. No.: 10/126,512

(22) Filed: Apr. 22, 2002

(30) Foreign Application Priority Data
Apr. 25, 2001 (JP) 01/126834

(51) Int. Cl. H01B 1/00

(52) U.S. Cl. 252/500

(57) ABSTRACT

A negative actinic ray-sensitive paste prepared by adding a conductive powder and optionally a heat-fusable inorganic powder to a negative actinic ray-sensitive composition; and

a pattern-forming method which comprises the following steps:

(1a) a step of laminating the negative actinic ray-sensitive paste onto the surface of a substrate to form a paste film layer,

(2a) a step of irradiating an actinic ray or heat ray through a mask or directly onto the surface of the paste film layer so as to obtain a predetermined pattern, and

(3a) a step of removing the paste film layer by a developing treatment so as to obtain a predetermined pattern.

### BACKGROUND OF THE INVENTION

(1) Field of the Invention

The present invention relates to a negative actinic ray-sensitive paste and a pattern-forming method by use of the same.

(2) Description of Background Art

The lithography by use of photoexposure technology has been applied in the art to a printed-circuit board, display panel, etc. as a method of forming a pattern on plastics, inorganic materials, etc.

As the above pattern-forming method, for example, a pattern-forming method is known in the art, which method comprises coating onto the surface of a substrate a photosensitive paste (see Japanese Patent Application Laid-Open No. 304923/97) prepared by adding an electrically conductive metal fine particle, a polymerization initiator and a glass frit to a photosensitive compound to form a photosensitive conductive layer, followed by irradiating a visible light onto the surface of the photosensitive conductive layer, subjecting a cured conductive layer to a developing treatment to obtain a predetermined conductive pattern, and by calcining to form a predetermined pattern. However, the above pattern-forming method had such drawbacks that the printed circuit board is poor in precision, that an unsatisfactory photosensitivity of the conductive layer makes it impossible to obtain a sharp pattern, and that difficulties of forming a thick conductive layer limit a scope of its applications.

### SUMMARY OF THE INVENTION

It is an object of the present invention to provide a pattern-forming method capable of providing a printed circuit board, etc. having a high precision by use of a particular negative actinic ray-sensitive paste.

It is another object of the present invention to provide a pattern-forming method capable of forming a conductive layer showing a satisfactory photosensitivity and capable of forming a sharp pattern by use of a particular negative actinic ray-sensitive paste.

It is still another object of the present invention to provide a pattern-forming method capable of providing a thick conductive layer with high performances without limitations to applications.

That is, the present invention provides a negative actinic ray-sensitive paste prepared by adding a conductive powder and optionally a heat-fusable inorganic powder to a negative actinic ray-sensitive composition.

The present invention provides a pattern-forming method which comprises the following steps:

(1a) a step of laminating the negative actinic ray-sensitive paste onto the surface of a substrate to form a paste film layer,

(2a) a step of irradiating an actinic ray or heat ray through a mask or directly onto the surface of the paste film layer so as to obtain a predetermined pattern, and

(3a) a step of removing the paste film layer by a developing treatment so as to obtain a predetermined pattern.

The present invention provides a pattern-forming method which comprise the following step:

(1b) a step of coating the negative actinic ray-sensitive paste onto the surface of a release film and optionally drying to obtain a dry film having a paste film layer, followed by laminating the dry film onto the surface of a substrate so that the surface of the paste film in the dry film may face and join to the surface of the substrate and stripping the release film from the surface of the paste film layer.

(2b) a step of irradiating an actinic ray or heat ray through a mask or directly onto the surface of the paste film layer so as to obtain a predetermined pattern, and

(3b) a step of removing the paste film layer by a developing treatment so as to obtain a predetermined pattern.

The present invention provides a pattern-forming method which comprises the following steps:

(1c) a step of coating the negative actinic ray-sensitive paste onto the surface of a release film and optionally drying to obtain a dry film having a paste film layer, followed by laminating the dry film onto the surface of the substrate so that the surface of the paste film may face and join to the surface of the substrate,

(2c) a step of irradiating an actinic ray or heat ray through a mask or directly onto the surface of the dry film so as to obtain a predetermined pattern, followed by stripping the release film from the surface of the paste film layer, and

(3c) a step of removing the paste film layer by a developing treatment so as to obtain a predetermined pattern.

### DETAILED DESCRIPTION OF THE INVENTION

The negative actinic ray-sensitive paste in the present invention is prepared by adding a conductive powder and optionally a heat-furable inorganic powder to a negative actinic ray-sensitive composition.

The negative actinic ray-sensitive composition includes such ones that a coating film in an area where an actinic ray such as a visible light, ultraviolet light, heat ray or the like is irradiated, is cured to be insoluble in a developing solution, and a coating film in an area where the actinic ray is not irradiated, is dissolved in the developing solution, resulting in forming a resist pattern coating film, for example, a negative visible light-sensitive resin composition, negative ultraviolet light-sensitive resin composition, negative heat ray-sensitive resin composition and the like.

The negative visible light-sensitive resin composition may include any ones known in the art, for example, ones containing a photocurable resin, photoreaction initiator, and optionally a photosensitizer.

The photocurable resin may include any known photocurable resins having a photocurable group crosslinkable on photoirradiation and having such an ionic group, i.e. anionic group or cationic group, in the resin that an unexposed coating film may be dissolved in an alkaline developing solution or an acid developing solution to be removed without particular limitations. Examples of an unsaturated group as the photocurable group contained in the photocurable resin may include acryloyl group, methacryloyl group, vinyl group, styryl group, allyl group and the like.

A typical example of the anionic group as the ionic group may include carboxyl group. A carboxyl group content may be such that an acid value of the resin is preferably in the range of about 10 to 700 mg KOH/g, particularly about 20 to 600 mg KOH/g. When the acid value is less than about 10 mg KOH/g, a poor solubility of an uncured coating film during the ddeveloping treatment by use of the developing solution results drawbacks of unsatisfactory removal. On the other hand, when the acid value is more than about 700 mg/KOH/g, a resist film or a cured coating film may easily come away, resulting in drawbacks of making it impossible to form a satisfactory pattern. A typical example of the cationic group may include amino group. An amino group content may preferably be such that an amine value of the resin is in the range of about 20 to 650, particularly about 30 to 600. An amine value less than about 20 results drawbacks of unsatisfactory removal of the uncured coating film as above mentioned. On the other hand, an amine value more than about 650 may undesirably result such drawbacks that the resist film may easily come away.

The anionic resin may include, for example, ones prepared by reacting polycarboxylic acid resin with a monomer such as glycidyl (meth)acrylate and the like so as to introduce unsaturated group and carboxyl group into the resin.

The cationic resin may include, for example, a resin prepared by an addition reaction between a hydroxyl group and tertiary amino group-containing resin and a reaction product of a hydroxyl group-containing unsaturated compound with a diisocyanate compound.

Details of the anionic resin and the cationic resin may be referred to the photocurable resin disclosed in Japanese Patent Application Laid-Open No. 223759/91.

The photoreaction initiator may include ones known in the art, for example, aromatic carbonyl compounds such as benzophenone, benzoin methyl ether, benzoin isopropyl ether, benzylxanthone, thioxanthone, anthraquinone and the like; acetophenones such as acetophenone, propiophenone, α-hydroxyisobutylphenone, α,α′dichloro-4-phenoxyacetophenone, 1-hydroxy-1-cyclohexylacetophenone, diacetylacetophenone, and the like; organic peroxides such as benzoyl peroxide, t-butylperoxy-2-ethylhexanoate, t-butylhydroperoxide, di-t-butyl-diperoxyisophtharate, 3,3′,4,4′-tetra (t-butylperoxycarbonyl)benzophenone and the like; diphenyl halonium salts such as diphenyliodomium bromide, diphenyliodonium chloride and the like; organohalides such as carbon tetrabromide, chloroform, iodoform and the like; heterocyclic and polycyclic compounds such as 3-phenyl-5-isooxazolone, 2,4,6-tris (trichloromethyl)-1,3,5-triazine benzanthrone and the like; azo compounds such as 2,2′-azo (2,4-dimethylvaleronitrile), 2,2′-azobisisobutylonitrile, 1,1′-azobis(cyclohexane-1-carbonitrile), 2,2′-azobis(2-methylbutylonitrile) and the like; iron-allene complex (see European Patent No. 152377), titanocene compound (see Japanese Patent Application Laid-Open No. 221110/88), bisimidazole based compounds; N-arylglycidyl based compounds; acrydine based compounds; combinations of aromatic ketone with aromatic amine; peroxyketal (see Japanese Patent Application Laid-Open No. 321895/94), and the like. Of the above radical photopolymerization initiators, di-t-butyldiperoxyisophthalate, 3,3′,4,4′-tetra (t-butylperoxycarbonyl) benzophenone, iron-allene complex and titanocene compound are preferable because of high activity on crosslinking or polymerization.

Trade names, of the radical photopolymerization initiator may include Irgacure 651 (marketed by Ciba Geigy Limited, trade name, acetophenone based radical photopolymerization initiator), Irgacure 184 (marketed by Ciba Geigy Limited, trade name, acetophenone based radical Photopolymerization initiator), Irgacure 1850 (marketed by Ciba Geigy Limited, trade name, acetophenone based radical photopolymerization initiator), Irgacure 907 (marketed by Chiba Geigy Limited, trade name, aminoalkylphenone based radical photopolymerization initiator), Irgacure 369 (marketed by Ciba Geigy Limited, trade name, aminoalkylphenone based radical photopolymerization initiator), Lucirin TPO (marketed by BASF Ltd., trade name, 2,4,6-trimethylbenzoyl diphenylphosphine oxide), Kayacure DETXS (marketed by Nippon Kayaku Co., Ltd., trade name), CGI-784 (marketed by Ciba Geigy Limited, trade name, titanium complex compound), and the like. These may be used alone or in combination. Of these, the titanocene compound is particularly preferable.

A mixing amount of the photoreaction initiator is in the range of 0.1 to 25 parts by weight, preferably 0.2 to 10 parts by weight per 100 parts by weight of the photocurable resin.

The photosensitizer may include known photosensitive dyes.

Examples of photosensitive dyes may include ones based on thioxanthene, xanthene, ketone, thiopyrylium salt, base styryl, merocyanine, 3-substituted coumarine, 3,4-substituted coumarine, cyanine, acrydine, thiazine, phenothiazine, anthracene, coronene, benzanthracene, perylene, merocyanine, ketocoumarine, fumarine, borate, and the like. These may be used alone or in combination. The borate based photosensitive dyes may include ones disclosed in, for example, Japanese Patent Application Laid-Open Nos. 241338/93, 5885/95 and 225474/95.

Of these, particularly of the borate based photosensitive dyes and coumarine based photosensitive dyes, NKX-1595 (trade name, 10-(2-Benzothiazolyl)-2,3,6,7-tetrahydro-1,1,7,7-tetramethyl 1H, 5H, 11H-[1]benzopyrano[6,7,8ij]quinolizin-11-one) is preferable.

In addition to the above resins, a saturated resin may also be used. The saturated resin may be used for the purpose of inhibiting the solubility of a photopolymerizable composition, for example, as inhibitors of the solubility of the resist film in the alkaline developing solution, and the solubility in a strong alkali solution as used on removal of a photocured coating film. Examples of the saturated resin may include polyester resin, alkyd resin, (meth)acrylic resin, vinyl resin, epoxy resin, phenolic resin, natural resin, synthetic rubber, silicone resin, fluorocarbon resin, polyurethane resin and the like. These resins may be used alone or in combination.

The organic solvent based negative visible light-sensitive resin composition may include ones prepared by dissolving or dispersing the above visible light-sensitive resin composition into an organic solvent such as ketones, esters, ethers, cellosolves, aromatic hydrocarbons, alcohols, halogenated hydrocarbons and the like.

In addition to the above visible light-sensitive resin composition, a water-developable visible light-sensitive resin composition may be used. The water-developable visible light-sensitive resin composition may include, for example, such a water based resin as to have a photopolymerizable unsaturated group and ion-forming group in a novolac phenol type epoxy resin. The water based resin may be prepared by a process which comprises subjecting a part of the epoxy groups contained in the novolac phenol type epoxy resin and (meth)acrylic acid to addition reaction to make the resin photopolymerizable and reacting the epoxy group with, for example, a tertiary amine compound to form a water-soluble onium salt group. The above resin is such that an exposed area is photocured to be water-insoluble, but an unexposed area is water-developable due to the ion-forming group, and that volatilization of the ion-forming group by the post heating of the resin at about 140 to 200° C. for 10 to 30 minutes makes a coating film hydrophobic, resulting in making it possible to form a coating film free of a hydrophilic group such as carboxyl group, amino group and the like, and salts thereof, i.e. salts due to the developing solution in the resist film as in the above alkaki or acid-developable, photocurable resin composition, and showing good resist properties. In addition to the above water based resin, a radical polymer may also be used, which is prepared by a process which comprises subjecting a homopolymer of an epoxy group-containing radically polymerizable unsaturated monomer such as glycidyl (meth)acrylate, 3,4-epoxy cyclohexyl alkyl (meth)acrylate, vinyl glycidyl ether and the like or a copolymer of at least one of the above monomers with other radically polymerizable unsaturated monomer such as C₁₋₂₄ alkyl or cycloalkyl (meth)acrylates, radically polymerizable unsaturated aromatic compounds and the like, other than the movolac phenol type epoxy resin, and (meth)acrylic acid to addition reaction to make the resin photopolymerizable and reacting the epoxy group with, for example, a tertiary amine compound to form a water-soluble onium salt group.

The above resin compositions may be coated onto a substrate by a coating method such as a roller coating, roll coater coating spin coater coating, curtain roll coater coating, spray coating, electrostatic coating, dip coating, silk printing, spin coating and the like, followed by optionally setting, and drying to obtain a resist film.

The surface of the photosensitive resist film may be covered with a cover coat layer prior to being exposed to light for curing. The above cover coat layer may be used as a barrier to oxygen in air so that deactivation by oxygen of radicals generated on exposure to light may be controlled, resulting in smoothly proceeding curing of photosensitive materials by exposure to light.

A negative visible light-sensitive resin water based resist composition may be obtained by dissolving or dispersing the above negative visible light-sensitive resin composition into water.

Dissolving or dispersing of the water based photosensitive resin composition into water may be carried out by neutralizing an anionic group such as carboxyl group in the photopolymerizable composition with an alkaki as a newtralizing agent, or by neutralizing a cationic group such as amino group in the photopolymerizable composition with an acid as a neutralizing agent respectively. The water-developable composition may directly be dispersed or dissolved into water.

A negative visible light-sensitive resin coating film prepared by coating an organic solvent based or water based negative visible light-sensitive resin composition onto a substrate may directly be exposed to light so that a predetermined resist film or a printed image may be obtained, followed by subjecting an unexposed area of the coating film to a developing treatment with a developing solution so as to be removed.

A light source to be used in photocuring may include ones known in the art, for example, light sources obtained from ultrahigh pressure mercury lamp, high pressure mercury lamp, moderate pressure mercury lamp, low pressure mercury lamp, chemical lamp, carbon arc lamp, xenone lamp, metal halide lamp, tungsten lamp, and the like; various lasers having an oscillating curve in a visible light region, and specifically argon laser having an oscillating curve in 488 nm, YAG-SHG laser having an oscillating curve in 532 nm and UV laser having an oscillating curve in the range of 351 to 364 nm.

An anionic negative visible light-sensitive resin composition may be subjected to an alkaline developing treatment, and a cationic one may be subjected to an acid developing treatment.

The negative visible light-sensitive dry film may be obtained, for example, by coating the negative visible light-sensitive resin composition onto a release paper such as polyethylene terephthalate, and drying to volatilize water and the organic solvent. In use, the release paper may be removed.

The negative ultra violet light-sensitive resin composition may include ones containing the above-mentioned photocurable resin and the above-mentioned photoreaction initiator. The negative ultra violet light-sensitive resin composition can form a pattern in the same manner as in the negative visible light-sensitive resin composition. A light source used for photocuring may include ones known in the art, for example, light sources obtained from ultrahigh pressure mercury lamp, high pressure mercury lamp, moderate pressure mercury lamp, low pressure mercury lamp, chemical lamp, carbon arc lamp, xenone lamp, metal halide lamp, tungsten lamp, and the like.

Of the negative heat-sensitive resin composition, an organic solvent based negative heat-sensitive resin composition may include ones prepared by dissolving or dispersing a resin composition crosslinkable by a heat ray such as infrared ray and the like into an organic solvent. The resin composition may include ones known in the art, for example, hydroxyl group-containing resin/amino resin, hydroxyl group-containing resin/blocked isocyanate, melamine resin, silicone resin containing a hydrolyzable group such as alkoxysilyl group, hydroxysilyl group and the like or acrylic resin, epoxy resin/phenolic resin, epoxy resin/(anhydrous) carboxylic acid, epoxy resin/polyamine, unsaturated resin/radical polymerization catalyst such as peroxide, carboxyl group and/or hydroxyphenyl group/ether linkage-containing olefinically unsaturated compound, and the like.

The water based negative heat-sensitive resin composition may include ones prepared by introducing an acidic group or a basic group into a resin crosslinkable with a heat ray such as infrared rays and the like, followed by neutralizing with a neutralizing agent such as a basic compound or an acidic compound respectively, and by dissolving or dispersing into water.

A negative heat-sensitive dry film may be obtained, for example, by the negative heat-sensitive resin composition onto a release paper such as polyethylene terephthalate, and drying to volatilize water and the organic solvent. In use the release paper may be removed.

A coating film formed from the negative heat-sensitive resin composition is directly sensitized with heat rays so that a predetermined coating film pattern may be obtained, followed by subjecting a developing treatment with a developing solution such as an organic solvent, acid, or alkali developing solution to remove an unexposed part of the coating film. Examples of the heat rays may include a semiconductor laser (830 nm), YAG laser (1.06 μm), etc.

Formation of a resist pattern coating film of the actinic ray-sensitive coating film may be followed by removing an exposed non-actinic ray-sensitive coating film by a developing treatment.

The developing treatment may be carried out by use of the same developing solution and developing conditions as in the negative photosensitive resin composition.

The conductive powder used in the paste of the present invention may include the conductive pigments known in the art, for example, metals such as silver, copper, iron, manganese, nickel, aluminum, cobalt, chromium, lead, zinc, bismuth, indium tin oxide (ITO) and the like, at least one alloy thereof, oxides thereof, ones prepared by coating or metallizing the conductive materials onto the surface of an insulating material, and the like, and may also include ones other than metals and having conductivity, for example, a conductive polymer, etc.

The conductive powder may also include tin dioxide powder doped with antimony [hereinafter may be referred to as tin oxide/antimony (dope)], which is such that doping the tin dioxide component as a semiconductor material with the antimony component forms a doner level of electrons so as to improve conductivity. Examples thereof may include the tin oxide/antimony (dope) alone and coating products prepared by coating the tin oxide/antimony (dope) onto other substrates, for example, titanium oxide, potassium titanate, aluminum borate, barium sulfate, mica, silica, etc.

A mixing amount the conductive powder is in the range of 10 to 90% by weight, preferably 50 to 80% by weight.

The paste of the present invention may contain a glass frit to improve adhesion properties to a glass base plate. In the case where heat curing of a plasma display onto a glass base plate is carried out, both glass transition temperature (Tg) and glass softening temperature (Ts) are preferably in the range of 300 to 800° C. and 400 to 600° C. respectively. More preferably, the Tg is in the range of 400 to 600° C. A Tg lower than 300° C. undesirably causes to take place sintering before evaporation of organic components such as a polymer binder, monomer and the like takes place.

A mixing amount of the glass frit is preferably in the range of 1 to 10% by weight, more preferably 1 to 5% by weight. From the standpoint of lowering resistance of an electrode of plasma display, the mixing amount of the glass component is preferably as low as possible. Since the glass frit is electrically insulating, a mixing amount more than 10% by weight undesirably increases the resistance of the electrode. A mixing amount less than 1% by weight makes it difficult to obtain a strong adhesive strength between an electrode membrane and the glass base plate. Further, mixing amounts of respective components are preferably as follows.

The paste of the present invention may optionally contain other coloring agents, for example, color pigments such as carbon black and the like, dyes, etc., fillers, additives, etc.

The organic solvent based negative photosensitive or heat-sensitive resin composition may be prepared by dissolving or dispersing the negative photosensitive or heat-sensitive resin composition into an organic solvent such as ketones, esters, ethers, cellosolves, aromatic hydrocarbons, alcohols, halogenated hydrocarbons and the like respectively.

The water based negative photosensitive or heat-sensitive resin composition may be prepared by dissolving or dispersing the negative photosensitive or heat-sensitive resin composition into water respectively.

Dissolving or dispersing of the water based photosensitive or heat-sensitive resin composition into water may be carried out by neutralizing carboxyl group or amino group in the negative photosensitive or heat-sensitive resin composition with alkali or acid as a neutralizing agent respectively.

The above organic solvent based or water based negative photosensitive or heat-sensitive resin composition may be coated onto a substrate by a coating method such as roller, roll coater, spin coater, curtain flow coater, spray, electrostatic coating, dipcoating, silk printing, spin coating, etc., followed by optionally setting and drying to obtain a paste coating film.

A dry film, while is prepared by coating or printing the water based or organic solvent based negative photosensitive or heat-sensitive resin composition onto the surface of a release sheet such as polyethylene terephtharate sheet, followed by drying at room temperature or heat curing, for example, at 80° C. for 30 minutes to form a cured or uncured paste coating film, may also be used.

The pattern-forming method of the present invention is explained hereinafter.

The present invention provides a pattern-forming method which comprises the following steps:

(1a) a step of laminating the negative actinic ray-sensitive paste onto the surface of a substrate to form a paste film layer,

(2a) a step of irradiating an actinic ray or heat ray through a mask or directly onto the surface of the paste film layer so as to obtain a predetermined pattern, and

(3a) a step of removing the paste film layer by a developing treatment so as to obtain a predetermined pattern.

Step (1a):

The negative actinic ray-sensitive paste used in the step (1a) may include a liquid paste prepared by adding a conductive powder and an inorganic powder to the water based or organic solvent based negative photosensitive or heat-sensitive resin composition respectively.

The paste has a solid content preferably in the range of 10 to 90% by weight, particularly 50 to 80% by weight.

The paste may be coated or printed onto a substrate by a coating method such as roller, roll coater, spin coater, curtain flow coater, spray, electrostatic coating, dipcoating, silk printing, spin coating, etc., followed by optionally setting and heating to obtain a paste coating film. The heating may preferably be carried out under the conditions of 50 to 130° C., particularly 80 to 120° C. for 5 to 60 minutes, particularly 10 to 30 minutes.

A thickness of the paste film layer may vary depending on its uses, but is in the range of about 1 to 100 μm, particularly about 2 to 80 μm in the case of coating or printing of a black matrix, etc., and is in the range of about 100 μm to 10 mn, particularly about 200 μm to 5 mn in the case of being subjected to fabrication to be used as a substrate.

The paste may be coated onto any substrate as needed without particular limitations. Examples of the substrate may include a glass substrate, conductive metal-metallized base plate such as indium tin oxide (ITO) base plate, aluminum plate, chromium plate and the like, ceramic base plate, plastic base plate, etc.

Step (2a):

An irradiation source of the actinic ray irradiated onto the surface of the paste film and used in the step (2a) may include ones known in the art, for example, light sources obtained from ultrahigh pressure mercury lamp, high pressure mercury lamp, moderate pressure mercury lamp, low pressure mercury lamp, chemical lamp, carbon arc lamp, xenone lamp, metal halide lamp, tungsten lamp, sunlight and the like; various lasers having an oscillating curve in a visible light region, and specifically argon laser having an oscillating curve in 488 nm, YAG-SHG laser having an oscillating curve in 532 nm and UV laser having an oscillating curve in the range of 351 to 364 nm. An irradiation dose may be in the range of usually 10⁻¹ to 10³ mJ/cm², preferably 1 to 10² mJ/cm².

The heat ray may include, for example, a semiconductor laser, YAG laser, etc.

Step (3a):

The developing treatment of the paste film layer used in the step (3a) may be carried out by use of an alkali developing solution in the case where an acidic group is introduced into the paste film, by use of an acid developing solution in the case where a basic group is introduced into the paste film, by use of an aqueous developing solution in the case a hydrophilic group is introduced into the resin, or by use of an organic solvent developing solution in the case where the paste film is soluble or dispersible in the organic solvent respectively.

The alkali developing solution may include an aqueous solution of an-alkaline compound, for example, monomethylamine, dimethylamine, trimethylamine, monoethylamine, diethylamine, triethylamine, monoisopropylamine, diisopropylamine, triisopropylamine, monobutylamine, dibutylamine, moethanolamine, diethanolamine, triethanolamine, dimethylaminoethanol, diethylaminoethanol, ammonia, caustic soda, caustic potash, sodium metasilicate, potassium metasilicate, sodium carbonate, tetraethylammonium hydroxide, and the like.

An alkaline substance content in the above developing solution preferably in the range of 0.05 to 10% by weight.

The acid developing solution may include an aqueous solution of an acid compound, for example, formic acid, crotonic acid, acetic acid, propionic acid, lactic acid, hydrochloric acid, sulfuric acid, nitric acid, phosphoric acid, and the like.

The organic solvent may include, for example, hydrocarbons such as hexane, heptane, octane, toluene, xylene, dichloromethane, chloroform, carbon tetrachloride, trichloroethylene and the like; alcohols such as methanol, ethanol, propanol, butanol and the like; ethers such as diethyl ether, dipropyl ether, dibutyl ether, ethyl vinyl ether, dioxane, propylene oxide, tetrahydrofuran, cellosolve, methylcellosolue, butylcellosolve, methylcarbitol, diethylene glycol monoethyl ether and the like; ketones such as acetone, methyl ethyl ketone, methyl isobutyl ketone, isophorone, cyclohexanone and the like; esters such as methyl acetate, ethyl acetate, propyl acetate, butyl acetate and the like; other solvents such as pyridine, formamide, N,N-dimethylformamide and the like, and the like.

The developing treatment may be carried out by spraying or dipping under the conditions of a developing solution temperature of 10 to 80° C., preferably 15 to 50° C., and a developing time of 10 seconds to 20 minutes, preferably 15 seconds to 15 minutes.

The paste film layer is such that a finally formed film has a volume resistivity preferably in the range of 10⁻⁴ Ω·cm or less.

The present invention provides a pattern-forming method which comprises the following steps:

(1b) a step of coating the negative actinic ray-sensitive paste onto the surface of a release film and optionally drying to obtain a dry film having a paste film layer, followed by laminating the dry film onto the surface of a substrate so that the surface of the paste film in the dry film may face and join to the surface of the substrate and stripping the release film from the surface of the paste film layer,

(2b) a step of irradiating an actinic ray or heat ray through a mask or directly onto the surface of the paste film layer so as to obtain a predetermined pattern, and

(3b) a step of removing the paste film layer by a developing treatment so as to obtain a predetermined pattern.

Step (1b):

The release film may include any films used as a dry film in the art, for example, ones made of polyethylene terephtharate, polypropylene, polyethylene, polyvinyl alcohol, polyvinyl chloride, acrylic polymer, etc. The release film has a thickness preferably in the range of 5 to 200 μm, particularly 10 to 50 μm. Drying is carried out usually at 50 to 130° C., particularly 80 to 120° C. for 5 to 60 minutes, particularly 10 to 30 minutes.

The steps (2b) and (3b) may be carried out in the same manner as above mentioned.

The present invention provides a pattern-forming method which comprises the following steps:

(1c) a step of coating the negative actinic ray-sensitive paste onto the surface of a release film and optionally drying to obtain a dry film having a paste film layer, followed by laminating the dry film onto the surface of the substrate so that the surface of the paste film may face and join to the surface of the substrate,

(2c) a step of irradiating an actinic ray or heat ray through a mask or directly onto the surface of the dry film so as to obtain a predetermined pattern, followed by stripping the release film from the surface of the paste film layer, and

(3c) a step of removing the paste film layer by a developing treatment so as to obtain a predetermined pattern.

The above method of the present invention comprises irradiating actinic rays or heat rays onto the surface of the dry film, followed by stripping the release film from the surface of the paste film layer, and carrying out a developing treatment.

In the pattern-forming method of the present invention, the above developing treatment may be followed by calcining the paste film layer, for example, at about 300° C. to 800° C. for about 20 to 60 minutes to form a conductive coating film.

The above calcining step volatilizes the paste resin component and results fusion bonding, melting, etc. of the remaining conductive pigment component and the glass frit to form a conductive coating film.

The paste film formed by the present invention may be applicable to, for example, a black matrix conductive pattern, color filter conductive pattern, various kinds of display panel conductive pattern, plastic base plate or build-up base plate conductive pattern, etc.

Combinations of the above methods of the present invention makes it possible to form a bus electric pole or address electric pole pattern of a plasma display prepared by laminating a black conductive coating film layer or silver conductive coating film layer wholly or partly onto the surface of a transparent electrode pattern layer.

The present invention can provide a pattern-forming method capable of providing a printed circuit board, etc. having a high precision by use of a particular negative actinic ray-sensitive paste.

The present invention can provide a pattern-forming method capable of forming a conductive layer showing a satisfactory photosensitivity and capable of forming a sharp pattern by use of a particular negative actinic ray-sensitive paste.

The present invention can provide a pattern-forming method capable of providing a thick conductive layer with high performances without limitations to applications.

### EXAMPLE

The present invention is explained more in detail by: Preparation Examples and Examples, in which “part” and “%” represent “part by weight” and “% by weight” respectively.

### Preparation Example 1

(Preparation Example of Paste A by Use of Water Based Negative Photosensitive Anionic Composition)

A photocurable resin (resin solid content 55% by weight, propylene glycol monomethyl ether organic solvent, resin acid value 65 mg KOH/g, number average molecular weight about 20,000) was prepared by reacting 100 parts by weight of acrylic resin (resin acid value 293 mg KOH/g, styrene/acrylic acid weight ratio=80/20) with 125 parts by weight of glycidyl methacrylate. To 100 parts (as solid content) of the photocurable resin were added 3 parts of photopolymerization initiator (CGI-784, Trade name, marketed by Ciba Geigy Limited, titanocene compound) and one part of photosensitizer (WKX-1595, Trade name, marketed by Hayashibara Biochemical Laboratories, Inc.) to obtain a photosensitive solution.

To 100 parts (as solid content) of the photosensitive solution was added 9 parts of triethylamine to be mixed with agitation, followed by dispersing into deionized water to obtain a water-dispersed resin solution (solid content 15%).

To 100 parts (as solid content) of the water-dispersed resin solution were added 660 parts of silver powder and 33 parts of glass frit (P60 60%, B₂O₃ 20%, SiO₂ 15%, Al₂O₃ 5%, powder having a mean particle size of 1-6 μm), followed by subjecting to a pigment dispersion in a pebble mill to obtain a silver paste.

### Preparation Example 2

(Preparation of Paste B of Organic Solvent Based Negative Photosensitive Composition)

The photosensitive solution in Preparation Example 1 was dissolved in diethylene glycol dimethyl ether solvent to obtain an organic solvent based resin solution having a solid content of 30%.

To 100 parts (as solid content) of the organic solvent based resin solution were added 660 parts of silver powder and 33 parts of glass frit (P60 60%, B₂O₃ 20%, SiO₂ 15%, Al₂O₃ 5%, powder having a mean particle size of 1-6 μm), followed by subjecting to a pigment dispersion in a pebble mill to obtain a silver paste.

### Preparation Example 3

(Preparation Example of Paste C by Use of a Water Based Negative Photosensitive Cationic Composition)

A photocurable resin (amine value about 56, degree of unsaturation 1-83 moles/kg) was obtained by addition reaction of 15 parts of acrylic acid to 100 parts of acrylic copolymer of methyl acrylate/styrene/butyl acrylate/glycidyl methacrylate/dimethylaminolthyl methacrylate (weight ratio) 20/10/22/30/18.

To 100 parts of the photocurable resin were added 0.5 part of the photosensitizer used in Preparation Example 1, 55 parts of trimethylol propane triacrylate and 20 parts of the titanocene compound used in Preparation Example 1, followed by mixing to obtain a photosensitive solution.

To 100 parts (as solid content) of the photosensitive solution was added a parts of acetic acid, followed by mixing with agitation, and dispersing into deionized water to obtain a water-dispersed resin solution having a solid content of 15%.

To 100 parts (as solid content) of the water-dispersed resin solution were added 660 parts of silver powder and 33 parts of glass frit (P60 60%, B₂O₃ 20%, SiO₂ 15%, Al₂O₃ 5%, powder having a mean particle size of 1-6 μm), followed by subjecting to a pigment dispersion in a pebble mill to obtain a silver paste.

### Preparation Example 4

Preparation Example of Paste D of Organic Solvent Based Negative Heat-Sensitive Composition)

A hydroxyl group-containing acrylic resin (acrylic copolymer of methyl methacrylate/ethyl acrylate/hydroxyethyl acrylate/acrylic acid (weight ratio)=51/21.5/15/12.5) and a melamine resin (Nikalac MX600, Trade name, marketed by Sanwa Chemical Co., Ltd.) was mixed at a solid content weight ratio of 7 to 3 to obtain a toluene resin solution having a solid content of 50%.

To 100 parts (as solid content) of the photosensitive solution was added 7 parts of triethylemine to be mixed with agitation, followed by dispersing into deionized water to obtain a water-dispersed resin solution (solid content 15%).

To 100 parts (as solid content) of the water-dispersed resin solution were added 660 parts of silver powder and 33 parts of glass frit P60 60%, B₂O₃ 20%, SiO₂ 15%, Al₂O₃ 5%, powder having a mean particle size of 1-6 μm), followed by subjecting to a pigment dispersion in a pebble mill to obtain a silver paste.

### Preparation Example 5

(Preparation Example of Negative Dry Film (I))

The paste A was coated onto a polyethylene terephthalate film to as to be a dry film thickness of 20 μm by a roller coating, followed by setting and heating at 120° C. for 10 minutes to obtain the negative dry film (I).

### Preparation Example 6

(Preparation Example of Negative Dry Film (II))

The paste C was coated onto a polyethylene terephthalate film so as to be a dry film thickness of 20 μm by a roller coating, followed by setting and heating at 120° C. for 10 minutes to obtain the negative dry film (II).

### Preparation Example 7

(Preparation Example of Negative Dry Film (III))

The paste C was coated onto a polyethylene terephthalate film so as to be a dry film thickness of 20 μm by a roller coating, followed by setting and heating at 120° C. for 10 minutes to obtain the negative dry film (III).

### Example 1

The paste A was coated by a spin coater onto a whole surface of a base plate having on its surface a transparent electrode patterned on a transparent glass plate (200×200×0.1 mm) in the shape of a stripe of line (pattern width)/space=100/20 μm to form a conductive material coating film A having a film thickness of about 5 μm, followed by irradiating for exposing to light an argon laser (oscillating wave length 488 nm) of 70 mj/cm² directly onto the surface of negative photosensitive anionic coating film so as to form a line/space=50/100 μm and so that the coating film A may form a predetermined electrode pattern after development, dipping into an alkali developing solution(a) of 0.25 wt % sodium carbonate aqueous solution at 25° C. for 60 seconds for developing, leaving to stand at 450° C. for 30 minutes, and calcining at 575° C. for 30 minutes to obtain a base plate, with the results that a line residue properties, space developing properties, line shape after calcination were good respectively, and that the resulting conductive material coating film (electrode membrane) had a volume resistivity of 10⁻⁴ Ω·cm or less to be good.

### Example 2

Example 1 was duplicated except that the paste B was used in place of the paste A to obtain the paste B on the transparent glass plate, followed by irradiating for exposing to light an argon laser (oscillating wave length 488 nm) of 20 mj/cm² directly so as to form a line/space=50/100 μm and so that the conductive material coating film may form a predetermined electrode pattern after development, dipping into an alkali developing solution (b) of 1% aqueous acetic acid solution at 25° C. for 60 seconds for developing, leaving to stand at 450° C. for 30 minutes, and calcining at 575° C. for 30 minutes to obtain a base plate, with the results that a line residue properties, space developing properties, line shape after calcination were good respectively, and that the resulting conductive material coating film (electrode membrane) had a volume resistivity of 10⁻⁴ Ω·cm or less to be good.

### Example 3

Example 1 was duplicated except that the paste C was used in place of the paste A to obtain the paste C on the transparent glass plate, followed by irradiating for exposing to light an argon laser (oscillating wave length 488 nm) of 20 mj/cm² directly so as to form a line/space=50/100 μm and so that the conductive material coating film may form a predetermined electrode pattern after development, dipping into an alkali developing solution (a) at 25° C. for 60 seconds for developing, having to stand at 450° C. for 30 minutes, and calcining at 575° C. for 30 minutes to obtain a base plate, with the results that a line residue properties, space developing properties, line shape after calcination were good respectively, and that the resulting conductive material coating film (electrode membrane) had a volume resistivity of 10⁻⁴ Ω·cm or less to be good.

### Example 4

Example 1 was duplicated except that the paste D was used in place of the paste A to obtain the paste D on the transparent glass plate, followed by irradiating for exposing to light an infrared ray (oscillating wave length 830 nm) of 100 mj/cm² directly so as to form a line/space=50/100 μm and so that the conductive material coating film may form a predetermined electrode pattern after development, dipping into an alkali developing solution (a) at 25° C. for 60 seconds for developing, having to stand at 450° C. for 30 minutes, and calcining at 575° C. for 30 minutes to obtain a base plate, with the results that a line residue properties, space developing properties, line shape after calcination were good respectively, and that the resulting conductive material coating film (electrode membrane) had a volume resistivity of 10⁻⁴ Ω·cm or less to be good.

### Example 5

The dry film (I) was laminated onto a glass substrate so that a photosensitive surface of the dry film (I) may be folded on the glass substrate, followed by stripping the polyethylene terephthalate release film to form a conductive material coating film, irradiating for exposing to light an argon laser (oscillating wave length 488 nm) of 70 mj/cm² directly so as to form a line/space=50/100 μm and so that the conductive material coating film may form a predetermined electrode pattern after development, dipping into an alkali developing solution (a) of 0.25 wt % sodium carbonate aqueous solution at 25° C. for 60 seconds for developing, leaving to stand at 450° C. for 30 minutes, and calcining at 575° C. for 30 minutes to obtain a base plate, with the results that a line residue properties, space developing properties, line shape after calcination were good respectively, and that the resulting conductive material coating film (electrode membrane) had a volume resistivity of 10⁻⁴ Ω·cm or less to be good.

### Example 6

The dry film (II) was laminated onto a glass substrate so that a photosensitive surface of the dry film (II) may be folded on the glass substrate, followed by stripping the polyethylene terephthalate release paper to form a conductive material coating film, irradiating for exposing to light an argon laser (oscillating wave length 488 nm) of 20 mj/cm² directly so as to form a line/space=50/100 μm and so that the conductive material coating film may form a predetermined electrode pattern after development, dipping into the acid developing solution (b) at 25° C. for 60 seconds for developing an exposed area of the conductive material coating film, leaving to stand at 450° C. for 30 minutes, and calcining at 575° C. for 30 minutes to obtain a base plate, with the results that a line residue properties, space developing properties, line shape after calcination were good respectively, and that the resulting conductive material coating film (electrode membrane) had a volume resistivity of 10⁻⁴ Ω·cm or less to be good.

### Example 7

Example 5 was duplicated except that the dry film (III) was used in place of the dry film (I) to form a conductive material coating film on the transparent glass plate, followed by irradiating for exposing to light the above infrared ray directly so as to form a line/space=50/100 μm and so that the conductive material coating film may form a predetermined electrode pattern after development, dipping into the alkali developing solution (a) at 25° C. for 60 seconds for developing, leaving to stand at 450° C. for 30 minutes, and calcining at 575° C. for 30 minutes to obtain a base plate, with the results that a line residue properties, space developing properties, line shape after calcination were good respectively, and that the resulting conductive material coating film (electrode membrane) had a volume resistivity of 10⁻⁴ Ω·cm or less to be good.

What is claimed is:

1. A negative actinic ray-sensitive paste prepared by adding a conductive powder and optionally a heat-fusable inorganic powder to a negative actinic ray-sensitive composition.

2. A negative actinic ray-sensitive paste as claimed in claim 1, wherein the negative actinic ray-sensitive composition is a negative visible light-sensitive composition.

3. A negative actinic ray-sensitive paste as claimed in claim 1, wherein the negative actinic ray-sensitive composition is a negative ultraviolet light-sensitive composition.

4. A negative actinic ray-sensitive paste as claimed in claim 1, wherein the negative actinic ray-sensitive composition is a negative heat-sensitive composition.

5. A negative actinic ray-sensitive paste as claimed in claim 2, wherein the negative visible light-sensitive composition contains a photocurable resin, photopolymerization initiator and a photosensitizer.

6. A negative actinic ray-sensitive paste as claimed in claim 5, wherein the photopolymerization initiator is a titanocene compound.

7. A negative actinic ray-sensitive paste as claimed in claim 5, wherein the photosensitizer is at least one selected from dipyrromethene boron complex compound and 10-(2-Benzothiazolyl)-2,3,6,7-tetrahydro-1,1,7,7-tetramethy 11H,5H,11H-[1] benzopyrano[6,7,8ij]quinolizin-11-one.

8. A negative actinic ray-sensitive paste as claimed in claim 3, wherein the negative ultraviolet light-sensitive composition contains a photocurable resin.

9. A pattern-forming method which comprises the following steps:
(1a) a step of laminating the negative actinic ray-sensitive paste as claimed in claim 1 onto the surface of a substrate to form a paste film layer,
(2a) a step of irradiating an actinic ray or heat ray through a mask or directly onto the surface of the paste film layer so as to obtain a predetermined pattern, and
(3b) a step of removing the paste film layer by a developing treatment so as to obtain a predetermined pattern.

10. A pattern-following method which comprises the following steps:
(1b) a step of coating the negative actinic ray-sensitive paste as claimed in claim 1 onto the surface of a release film and optionally drying to obtain a dry film having a paste film layer, followed by laminating the dry film onto the surface of a substrate so that the surface of the paste film in the dry film may face and join to the surface of the substrate and stripping the release film from the surface of the paste film layer,
(2b) a step of irradiating an actinic ray or heat ray through a mask or directly onto the surface of the paste film layer so as to obtain a predetermined pattern, and
(3b) a step of removing the paste film layer by a developing treatment so as to obtain a predetermined pattern.

11. A pattern-forming method which comprises the following steps:
(1c) a step of coating the negative actinic ray-sensitive paste as claimed in claim 1 onto the surface of a release film and optionally drying to obtain a dry film having a paste film layer, followed by laminating the dry film onto the surface of the substrate so that the surface of the paste film may face and join to the surface of the substrate,
(2c) a step of irradiating an actinic ray or heat ray through a mask or directly onto the surface of the dry film so as to obtain a predetermined pattern, followed by stripping the release film from the surface of the paste film layer, and
(3c) a step of removing the paste film layer by a developing treatment so as to obtain a predetermined pattern.

12. A pattern-forming method as claimed in claim 9, 10 or 11, wherein the negative actinic ray-sensitive paste contains, as an essential ingredient, the heat-fusable inorganic powder, and the steps (3a), (3b) and (3c) are followed by a step of calcining respectively.
